(19) United States
(12) Patent Application Publication
(10) Pub. No.: US 2014/0164122 A1
(43) Pub. Date: Jun. 12, 2014

(54) Smart Device Location in Retail Environments

(71) Applicants: Alexander D. Wissner-Gross, Cambridge, MA (US); Murray M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Murray M. Sullivan, Murray, UT (US); Robert J. Wolf, Sandy, UT (US); Robert V. Brazell, Salt Lake City, UT (US)

(21) Appl. No.: 13/710,126

(22) Filed: Dec. 10, 2012

(51) Int. Cl. G06Q 30/02

(52) U.S. Cl. CPC G06Q 30/0261
USPC 705/14.58

(57) ABSTRACT

The present invention extends to methods, systems, and computer program products for identifying the location of a customer within a retail environment using a smart device carried by the customer. One or more transponders can be located in the retail environment and can communicate with the smart device to determine the location of the smart device. Once the location of the smart device is determined, customized content can be displayed to the customer carrying the smart device. The customized content can be related to a product that is displayed in proximity of the location of the smart device.

### CROSS-REFERENCE TO RELATED APPLICATIONS

This application claims priority to U.S. Provisional Patent Application No. 61/569,109 which was filed on Dec. 9, 2011 and titled “Smart Device Location In Retail Environments.”

### BACKGROUND

Advertising is the process through which companies attempt to convince customers to purchase their products. Advertising takes many forms including radio advertisements, in-store audio advertisements, television advertisements, billboards, etc. The production and broadcasting of these advertisements has become more and more expensive. Companies wish to maximize the effect of their advertisements by determining the most effective message to promote.

One of the major obstacles in creating effective advertising is determining a customer's response to a particular advertisement. Traditionally companies have used focus groups and surveys in order to obtain customer response information about their products and/or advertisements. This customer response information can then be used to adjust or manipulate their advertisements. Unfortunately, these techniques of generating customer response information have been found to be inadequate and often inaccurate. Therefore, there is a need for a new method of providing advertising information that is both efficient and reliable.

Another problem with maximizing the effectiveness of advertising is the significant time delay between obtaining the customer response data, creating the advertisement, and broadcasting the advertisement. In many circumstances, the initial data indicating what will be effective in advertising a particular product may expire or become inaccurate. Therefore, there is also a need for a process that is able to efficiently generate advertising information that is presented to a user at an effective time.

### BRIEF SUMMARY

The present invention extends to methods, systems, and computer program products for identifying the location of a customer within a retail environment using a smart device carried by the customer. One or more transponders can be located in the retail environment and can communicate with the smart device to determine the location of the smart device. Once the location of the smart device is determined, customized content can be displayed to the customer carrying the smart device. The customized content can be related to a product that is displayed in proximity of the location of the smart device.

In one embodiment, the present invention comprises a method for detecting the location of a smart device within a retail environment. One or more transponders receive a signal from a smart device. The signal is processed to determine the location of the smart device with respect to one or more of the transponders. The signal is also processed to identify an identity of a consumer carrying the smart device. Based on the identity of the consumer, content is identified and displayed to the consumer.

In another embodiment, the present invention comprises a method for locating a position of a smart device in a retail environment. A transponder located in the retail environment transmits a first signal to a smart device that is located within proximity of the transponder. In response to the first signal, a second signal is received from the smart device. The second signal is processed to compute a position of the smart device with respect to the transponder.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary retail environment in which a plurality of transponders are located;

FIGS. 2 and 3 illustrate exemplary transponders that can be used to implement the present invention;

FIG. 4 illustrates a flowchart of an exemplary method for detecting the location of a smart device within a retail environment; and

FIG. 5 illustrates a flowchart of an exemplary method for locating a position of a smart device in a retail environment.

### DETAILED DESCRIPTION

The present invention extends to methods, systems, and computer program products for identifying the location of a customer within a retail environment using a smart device carried by the customer. One or more transponders can be located in the retail environment and can communicate with the smart device to determine the location of the smart device. Once the location of the smart device is determined, customized content can be displayed to the customer carrying the smart device. The customized content can be related to a product that is displayed in proximity of the location of the smart device.

In one embodiment, the present invention comprises a method for detecting the location of a smart device within a retail environment. One or more transponders receive a signal from a smart device. The signal is processed to determine the location of the smart device with respect to one or more of the transponders. The signal is also processed to identify an identity of a consumer carrying the smart device. Based on the identity of the consumer, content is identified and displayed to the consumer.

In another embodiment, the present invention comprises a method for locating a position of a smart device in a retail environment. A transponder located in the retail environment transmits a first signal to a smart device that is located within proximity of the transponder. In response to the first signal, a second signal is received from the smart device. The second signal is processed to compute a position of the smart device with respect to the transponder.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

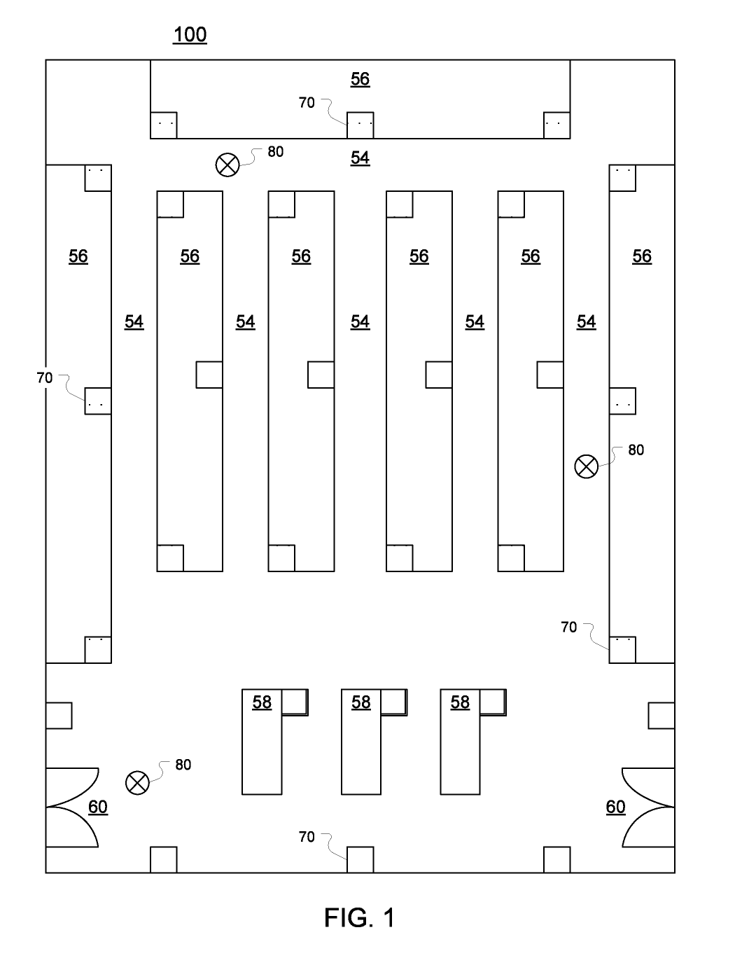

FIG. 1 illustrates an exemplary retail environment 100 in which the present invention can be implemented. Retail environment 100 can represent a layout of a grocery store, department store, or other type of store.

Retail environment 100 includes aisles 54 which are defined as spaces between shelving or display cases 56 on which merchandise is displayed. Retail environment 100 further includes checkout counters 58 where the consumer purchases selected merchandise. Retail environment 100 also includes entrances 60.

A plurality of transponders 70 are positioned throughout retail environment 100. Transponders 70 are generally positioned within retail environment 100 so as to be in proximity to a smart device 80 of a consumer as the consumer moves through the retail environment.

A smart device can comprise any type of device capable of transmitting and/or receiving a signal. Examples of smart devices include smart phones, mobile phones, tablets, PDAs, music or gaming devices, RFID cards, etc.

For example, in some embodiments, one or more transponders 70 are positioned in proximity to entrances 60. Thus, as a consumer having a smart device 80 enters retail environment 100, smart device 80 is placed in proximity to transponders 70. In other embodiments, one or more transponders 70 are positioned in proximity to aisles 54, such that a consumer's smart device 80 is placed in proximity to transponders 70 as the consumer moves through the aisle 54.

Transponders 70 can be positioned on a display case 56 where they are visible or hidden from consumers. Transponders 70 can also be positioned on a ceiling surface of retail environment 100. In other words, transponders 70 can be positioned in virtually any location in a retail environment.

A transponder 70 in accordance with the present invention comprises a device capable of receiving a signal from a smart device 80. Transponder 70 may also be capable of emitting a signal that is detectable by a smart device 80. Thus, transponder 70 and smart device 80 can be configured to communicate by emitting and receiving signals.

In some embodiments, a transponder comprises a nondescript device having circuitry for receiving and transmitting signals between the transponder and a smart device. In some embodiments, multiple transponders are interconnected via a network connection such that information or signals acquired by a first transponder is accessible to another transponder via the network connection. As such, a single transponder may detect the location of the smart device and communicate the location of the smart device to the remaining transponders of the smart device locating system. Further, two or more transponders may work in concert to determine the location of the smart device such as by triangulation or other methods for granular localization. Once the location of the device is determined, this information may be distributed to the remaining transponders via the network connection.

Transponders can comprise standalone units that serve only to locate smart devices, or can be incorporated into other devices or structures. For example, a transponder may be incorporated into a structure that displays static or dynamic advertisements or that displays products. Similarly, a transponder can be incorporated into a portion of a display case 56, a checkout counter 58, or another structure of retail environment 100 such as a wall, a light fixture, the ceiling, or the floor.

In some embodiments, transponder 70 comprises a video display such as a monitor or other display device. A video display may be desired where transponder 70 is positioned so as to be visible to a consumer. For example, a video display transponder 70 may be positioned on a visible surface of a display case 56. The video display transponder 70 may thus have a dual function of communicating with smart device 80 and displaying visual information to a consumer. In some instances, a video display transponder 70 displays information to a consumer related to a product or merchandise in proximity to the video display transponder 70. In other instances, a video display transponder 70 displays customized information to a consumer based upon information received from the consumer's smart device 80.

Transponder 70 may further comprise a camera which is configured to detect a smart device based upon the appearance or other characteristic of a consumer. For example, in some embodiments a consumer undergoes a registration process that links the consumer's image and identity to a smart device. In such cases, the camera of transponder 70 can detect a consumer by recognizing the consumer's image.

In other embodiments, transponder 70 can detect a consumer by recognizing a code or other data contained or displayed on or transmitted by the smart device or card. For example, transponder 70 can comprise a card reader that scans a code on a loyalty, credit, or other type of card. Alternatively, transponder 70 can receive signals from a smart device via Bluetooth, Near Field Communication, Infrared, Wi-Fi, or other similar wireless communication means.

In some embodiments, a consumer can download an application that allows the consumer to register his identity and the identity of the smart device with a server coupled to transponder 70. The application can display a code on smart device 80 that can be scanned by transponder 70. In some embodiments, transponder 70 can be configured to cause the application to prompt the user to scan the code.

In some embodiments, a smart device 80 can include a camera that detects when the consumer is in proximity to a transponder 70. For example, a camera can detect a physical appearance of transponder 70 or a code which is coupled to or otherwise associated with transponder 70. The camera can also detect video signals which are emitted from a video display of a transponder 70. For example, the camera can be configured to recognize a light pattern, sequence, intensity or color provided by a video display of a transponder 70. The camera can further be used to recognize a physical characteristic of the transponder's vicinity. For example, smart device 80 may include a map or digital representation of retail environment 100 which is used by smart device 80 to match and identify the location of smart device 80 or transponder 70 based upon a visual image received by the camera of smart device 80.

In some embodiments, transponder 70 comprises an audio device such as an audio speaker. An audio speaker may be desired where transponder 70 is positioned so as to be hidden from the view of a consumer. For example, an audio speaker transponder 70 may be located in a ceiling surface of retail environment 100. Further, an audio speaker may be incorporated into a transponder 70 having a video display. For example, a video display of a transponder 70 may be used exclusively for advertising purposes while an inaudible acoustic tone is emitted by an audio speaker of transponder 70 for purposes of locating the position of the consumer's smart device 80. A smart device 80 may be equipped with hardware and/or software capable of detecting the inaudible acoustic tone to thereby determine the proximity of the smart device 80 in relation to the transponder 70.

In some embodiments, transponders 70 can emit an audible acoustic tone that is detectable by smart device 80. In other embodiments, transponders 70 emit an audible acoustic tone comprising a first tone which is perceived by the consumer, and a second tone which is unperceivable by the consumer but is detected by smart device 80. For example, an audible acoustic tone may include a music track which is perceived by the consumer, and may further include masked acoustic information which is received and used by the consumer's smart device 80. The masked acoustic information may include data which communicates a location to the smart device 80. The masked acoustic information may further include data which communicates information concerning merchandise, products, prices, sales or other information regarding the immediate vicinity of the smart device 80.

In some embodiments, a smart device 80 is positioned between two or more transponders 70. Transponders 70 may be positioned strategically so that the location of the smart device can be determined via triangulation. In some instances, adjacent transponders are programmed to emit frequencies which are dispersed over a narrow range. A smart device 80 may take advantage of the varied intensities of the emitted tones to triangulate its position and to determine which transponder or transponders are in its proximity.

In other instances, transponders 70 are programmed to emit a plurality of frequencies which comprise a spread spectrum. Specifically, transponders 70 emit a plurality of frequencies which rapidly switch from one frequency to the next. Accordingly, smart device 80 comprises a live spectrum analyzer that detects and receives information from transponder 70. For example, smart device 80 may comprise an application which includes a live spectrum analyzer. In some embodiments, adjacent transponders 70 further comprise a live spectrum analyzer to enable communication between adjacent transponders 70.

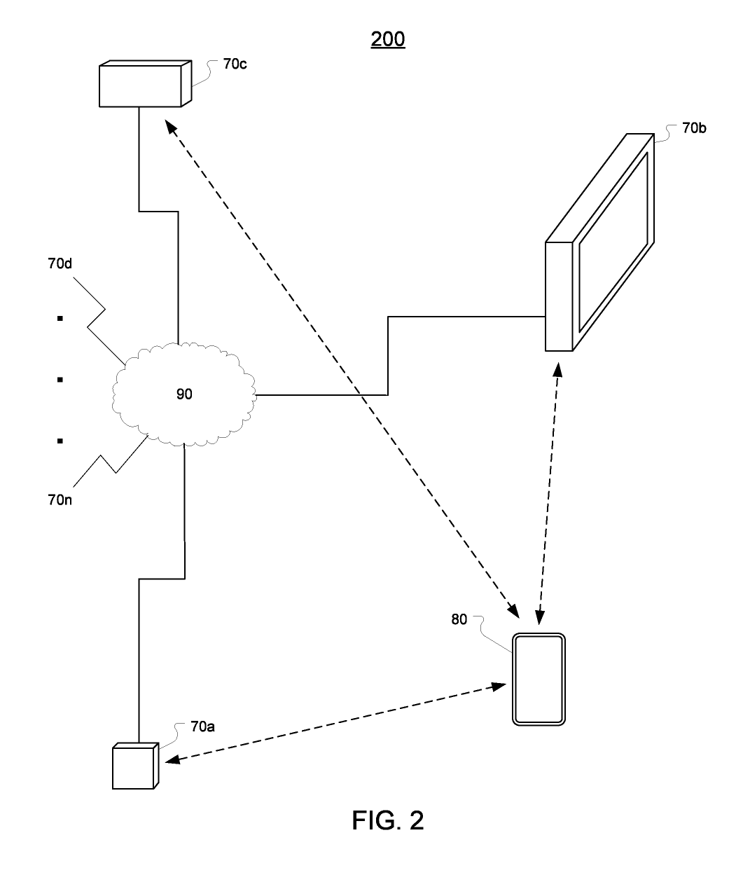

FIG. 2 illustrates an example retail environment 200 which includes various types of transponders 70a-70n that are interconnected via network 90. For example, transponder 70b is shown as being incorporated into a display device. Retail environment 200 can also include a computer system that controls transponders 70, although in some embodiments, one or more of transponders 70 may include the necessary circuitry and/or logic to not require control by a separate computer system. FIG. 2 also shows that smart device 80 is transmitting and/or receiving signals from transponders 70a, 70b, and 70c. At any given time, a smart device 80 can be in communication with any number of transponders. Based on these communications, the location of a smart device can be detected.

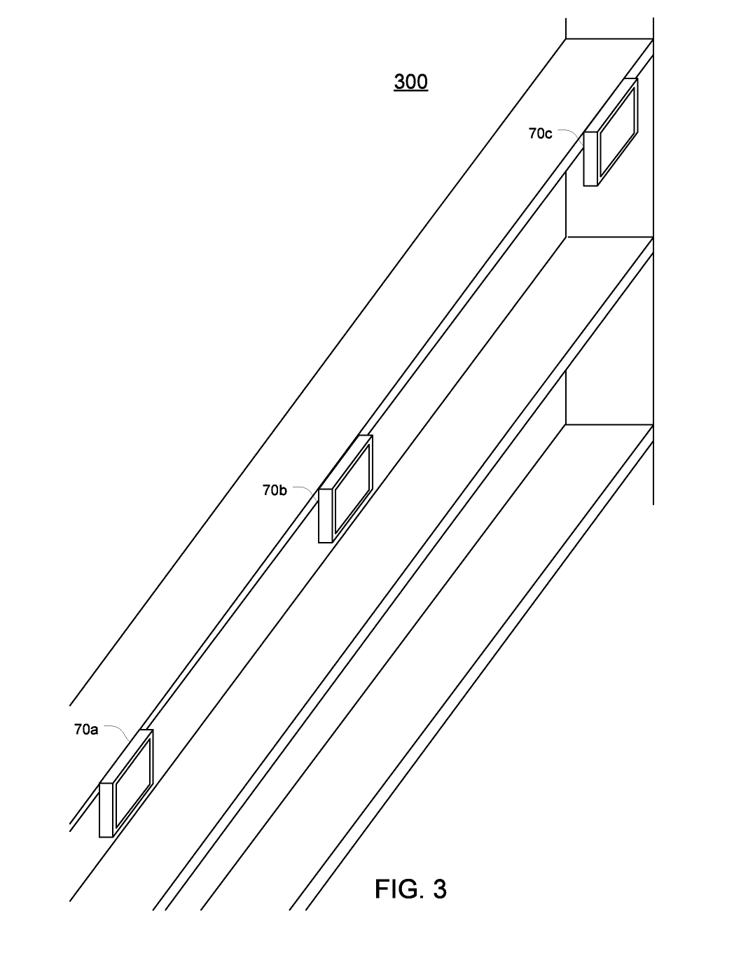

FIG. 3 illustrates an example retail environment 300 that includes three transponders 70a-70c that are each video displays mounted to a display shelve. In such embodiments, the video display can both display audio/video content and detect the presence of a smart device within proximity of the display.

Accordingly, the present invention can be implemented using any number and type of transponders 70 which communicate with smart devices 80 to determine the location of smart device 80 within a retail environment. The location of a smart device 80 can be determined by the smart device by receiving communications from one or more transponders 70, by one or more transponders 70 by receiving communications from a smart device and zero or more other transponders 70, or by both the smart device and one or more transponders by intercommunicating. Various examples of benefits that can be provided by implementations of the invention is provided below.

### Example 1

### Customer Identification

In some embodiments a system of transponders is positioned adjacent an entrance of a retail environment such that a smart device of a customer is detected upon the customer entering the retail environment through the entrance. The system of transponders is operably connected to a network and server which stores information which links the smart device to the identity of the customer. Accordingly, upon detecting and recognizing the customer's smart device, the server and/or transponder can address the customer using a personal greeting.

The system of transponders may further track the customer through the retail environment and provide customized instructions, greetings, commentary, or other information to enhance the customer's shopping experience.

### Example 2

### Customized Retail Experience

In some embodiments a system of transponders is positioned throughout a retail environment such that the system of transponders is capable of tracking a smart device through the retail environment. In some instances, a customer pre-registers a smart device with a server coupled to the system of transponders. As part of the preregistration process, a customer provides personal information which may be relevant to the customer's shopping or retail experience. Such personal information may include the customer's name, address, employment, likes, dislikes, etc. In some instances, the system of transponders utilizes the personal information of the customer to offer the customer personalized information regarding sales, coupons, product information, deals or other personalized information intended to enhance the customer's shopping and/or retail experience. In some embodiments, the customer is able to directly interface with the system of transponders to indicate whether the personalized information is acceptable or unacceptable. The system of transponders may further electronically transfer personalized information, such as a digital coupon, to the customer's smart device for use by the customer during the shopping experience.

### Example 3

### Localized and Personalized Customer Retail Experience

In some embodiments, a system of transponders is positioned throughout a retail environment to identify and track the movement of the smart device through a retail environment. The system of transponders may thus identify a specific position of a smart device within a location of the retail environment. The system of transponders may then provide personalized information to the smart device based upon the detected location of the smart device within the retail environment. For example, the system of transponders may correlate the detected position of the smart device with a product in the vicinity of the smart device. The system of transponders may then offer or provide personalized information to the smart device which relates to the nearby product such as information, coupons, deals, product information, suggestions for related items, or suggested recipes which incorporate the product. In some embodiments, the system of transponders can further utilize predetermined information about a customer when providing personalized information to the smart device based upon the determined location of the smart device within the retail environment.

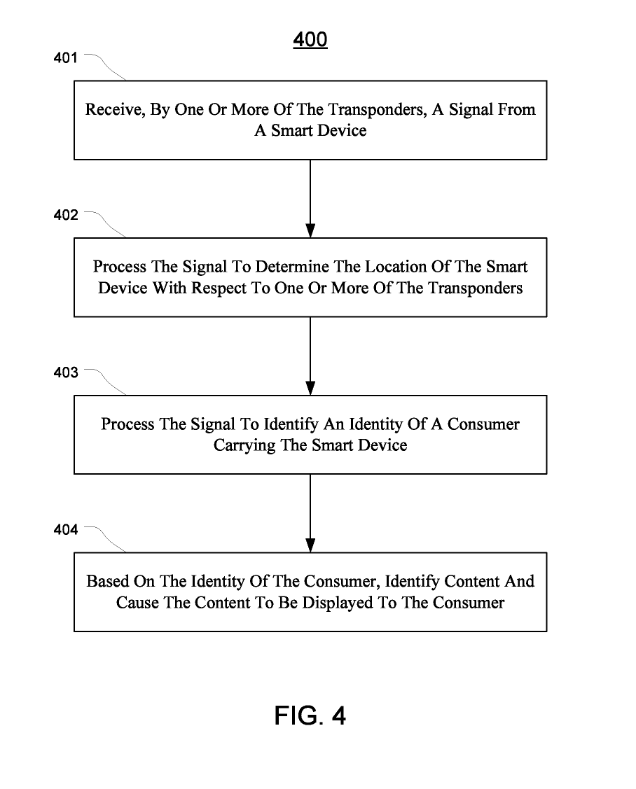

FIG. 4 illustrates a flowchart of an exemplary method 400 for detecting the location of a smart device within a retail environment. Method 400 will be described with reference to the figures.

Method 400 includes an act 401 of receiving, by one or more of the transponders, a signal from a smart device. For example, one or more of transponders 70 can receive a signal from smart device 80. The signal can be any type of signal including a wireless signal (e.g. Bluetooth, RFID, Infrared, Audio, Visual, NFC, etc.).

Method 400 includes an act 402 of processing the signal to determine the location of the smart device with respect to one or more of the transponders. For example, one or more of transponders 70 or a computer system interconnected to transponders 70 can process the signal.

Method 400 includes an act 403 of processing the signal to identify an identity of a consumer carrying the smart device. For example, one or more of transponders 70 or a computer system interconnected to transponders 70 can process the signal to identify the identity of a consumer using the device such as by looking up an account using an identifier included in the signal.

Method 400 includes an act 404 of, based on the identity of the consumer, identifying content and causing the content to be displayed to the consumer. For example, customized content can be displayed on a transponder or on the smart device.

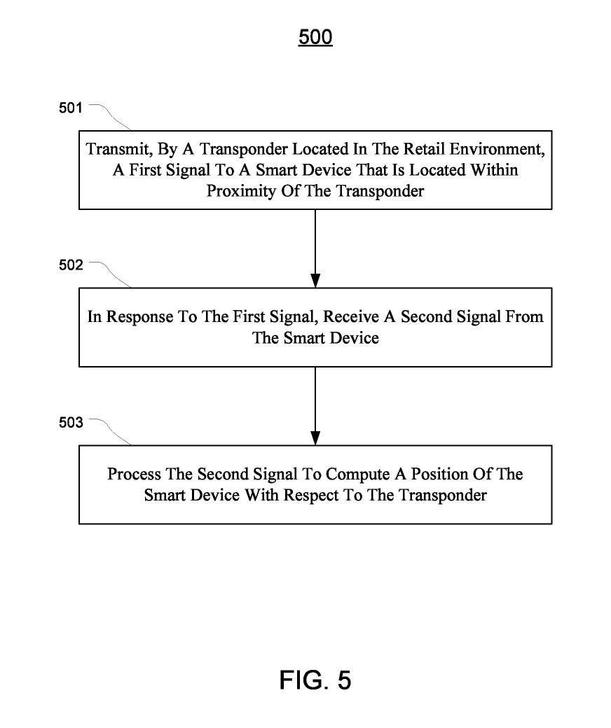

FIG. 5 illustrates a flowchart of an exemplary method 500 for locating a position of a smart device in a retail environment. Method 500 will be described with reference to the figures.

Method 500 includes an act 501 of transmitting, by a transponder located in the retail environment, a first signal to a smart device that is located within proximity of the transponder. For example, a transponder 70 can transmit a first signal to a smart device 80 in retail environment 100.

Method 500 includes an act 502 of in response to the first signal, receiving a second signal from the smart device. For example, the transponder 70 can receive a second signal from the smart device 80.

Method 500 includes an act 503 of processing the second signal to compute a position of the smart device with respect to the transponder. For example, the transponder 70 or a computer system connected to the transponder 70 can process the second signal to determine the position of the smart device 80.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a system of interconnected transponders, for detecting the location of a smart device within a retail environment, the method comprising:
receiving, by one or more of the transponders, a signal from a smart device;
processing the signal to determine the location of the smart device with respect to one or more of the transponders;
processing the signal to identify an identity of a consumer carrying the smart device; and
based on the identity of the consumer, identifying content and causing the content to be displayed to the consumer.

2. The method of claim 1, wherein the signal is received in response to one or more transponders transmitting a signal to the smart device.

3. The method of claim 1, wherein the signal comprises a wireless signal.

4. The method of claim 3, wherein the signal comprises a code contained on or displayed by the smart device.

5. The method of claim 1, wherein processing the signal to determine the location of the smart device with respect to one or more transponders comprises performing triangulation using multiple transponders that received the signal.

6. The method of claim 1, wherein processing the signal to identify an identity of the consumer comprises detecting an identifier in the signal, and using the identifier to locate an account of the consumer.

7. The method of claim 1, wherein the identified content comprises advertisements.

8. The method of claim 1, wherein the identified content comprises offers for products for sale that are located near one of the one or more transponders.

9. The method of claim 1, wherein causing the content to be displayed to the consumer comprises transmitting the content to the smart device for display on the smart device.

10. The method of claim 1, wherein causing the content to be displayed to the consumer comprises displaying the content on one or more of the transponders.

11. A method, performed by a transponder, for locating a position of a smart device in a retail environment, the method comprising:
transmitting, by a transponder located in the retail environment, a first signal to a smart device that is located within proximity of the transponder;
in response to the first signal, receiving a second signal from the smart device; and
processing the second signal to compute a position of the smart device with respect to the transponder.

12. The method of claim 11, wherein the second signal comprises at least one of an identity of the smart device or a user of the smart device.

13. The method of claim 11, wherein the transponder is a video display.

14. The method of claim 11, wherein the transponder is an audio device.

15. The method of claim 11, wherein the smart device is at least one of a smart phone, a personal digital assistant, a tablet computer, a media player, or a device having computer processing capabilities.

16. The method of claim 11, wherein the transponder is interconnected with a plurality of other transponders via a network.

17. The method of claim 16, wherein the first signal is transmitted by more than one transponder.

18. The method of claim 11, wherein at least one of the first and second signals comprises a plurality of frequencies.

19. The method of claim 18, wherein the plurality of frequencies comprises a spread spectrum.

20. The method of claim 11, further comprising:
in response to the second signal, determining an identity of a user of the smart device; and
generating content for display to the user, the content being customized based on the identity of the user.
